(19) United States
(12) Patent Application Publication
(10) Pub. No.: US 2002/0144616 A1
(43) Pub. Date: Oct. 10, 2002

(54) Apparatus for and method of exposing photo-sensitive printing plates

(76) Inventor: Thomas Carlson, Big Spring, TX (US)

Correspondence Address: Charles D. Gunter, Jr., Bracewell & Patterson, LLP, 201 Main Street, Suite 1600, Fort Worth, TX, 76102-3105, US

(21) Appl. No.: 09/828,044

(22) Filed: Apr. 6, 2001

(51) Int. Cl. B41C 1/00; B41N 6/00

(52) U.S. Cl. 101/401.1

(57) ABSTRACT

An apparatus for exposing photo-sensitive printing plates in preparation for using the plates to produce printed images comprising a liquid crystal device (LCD) wherein the LCD comprises a transparent liquid that when activated by an electrical signal becomes opaque to the transmission of light. A plurality of essentially identical LCDs are arrayed in a closely spaced regular pattern in the same plane wherein the array has approximately the same overall dimensions of a printing plate to be exposed. A light source is disposed behind the LCD array such that light from the light source passes through the LCD array and onto the printing plate. A computer system is connected to the LCD array and light wherein the activation of individual LCDs within the array and the activation of the light source is controlled by the computer. When the light source is turned on, the photo-sensitive printing plates are exposed in preparation for using the plates to produce printed images.

### BACKGROUND OF THE INVENTION

1. Field of the Invention

The present invention generally relates to the field of printing apparatus and methods, and more specifically, relates to a method of exposing photo-sensitive printing plates in preparation for using the plates to produce printed images.

2. Description of the Prior Art

The basic process of offset printing, in which ink is applied to a printing plate and transferred from the plate to paper, has been known and used for many years, and is a highly effective process for producing high quality printed images. Effective and efficient preparation of printing plates is a significant element in the printing process. In traditional methods of plate preparation, a photographic film of the image to be printed is prepared, the film is placed over an unexposed plate, typically formed of metal, which has a photo-sensitive coating, and light is directed onto the film. The exposed portions of the film block or reduce the transmission of light through the film and thus block or reduce exposure of the photo-sensitive coating on the plate in those areas. The light induces a chemical change in the coating material, so that, after exposure, the plate maybe treated to remove portions of the coating from the plate surface, preparing the plate for use. When the image to be printed is in color, color separations are made, and a film and plate are prepared for each separation, or portion of the image.

Although effective, the traditional process for preparing plates has certain disadvantages and drawbacks. The preparation of film is a distinct step in the preparation of the plate for printing, although the film itself is not directly used in the printing process. The distinct step of film preparation requires time, increases the total printing cost, and is a potential source of errors that can affect the final printing process and reduce the quality of the printed product. Development of the film also requires the use of chemicals that are potentially harmful to humans and to the environment, and which must therefore be carefully handled during use and properly disposed of after use. Therefore, it is desirable to eliminate the step of film preparation and utilize a “direct to plate” approach for preparing printing plates.

Efforts have been made to eliminate the use of film in the preparation of plates to overcome the disadvantages and drawbacks associated with the prior art. For example, a process of exposing plates using a laser beam has been disclosed. Although plates can be exposed with this process, it requires very careful control of both the direction of the laser beam and the interruption of the beam to block exposure of certain portions of the plate. The apparatus and control mechanisms required are thus complex and relatively costly, and the process is prone to error if control of the exact positioning and precise blocking of the beam is not maintained.

Another approach that has been disclosed uses a row of multi-cell elements to selectively filter and magnify back portions of light. A bar containing the elements is positioned over a photo-sensitive printing plate, and either the plate or the bar is moved while the transmission of light from the row of elements is controlled by activating or deactivating each element in the row. While this approach can also be effective, again, very precise control of movement and element activation is required to properly expose a plate without error. If control of either movement or element activation/deactivation is not controlled within very precise limitations, errors will result and the procedure will not be successful.

In addition to the control complexities associated with the foregoing examples of direct to plate technology, adoption of the known approaches requires complete replacement of conventional plate exposure equipment with costly new equipment. In general, the printing industry is highly cost competitive, and the high capital expenditure for equipment replacement can have a detrimental effect in terms of competitive ability. Therefore, what is needed is an apparatus and method for exposing photo-sensitive printing plates that eliminate the use of film, does not require relatively complex and costly equipment, and is not prone to error if control and exact positioning and precise blocking of the light is not maintained.

### SUMMARY OF THE INVENTION

It is an object of the present invention to provide an apparatus and method for exposing photo-sensitive printing plates that eliminate the use of film.

It is another object of the present invention to provide an apparatus and method for exposing photo-sensitive printing plates that is not prone to error if control, exact positioning or precise blocking of the light is not maintained.

It is yet another object of the present invention to provide an apparatus and method for exposing photo-sensitive printing plates that does not require relatively complex and costly equipment.

The present invention provides a method of exposing photo-sensitive printing plates, and apparatus for use therewith, that addresses the disadvantages of the use of film without introducing the error-prone complexities of the more recent prior art approaches, and without the high cost for complete replacement of plate preparation equipment. The method of the invention is also directly compatible with use of digital computers to generate and manipulate images and prepare text images for printing. It is a direct to plate approach, but without the need for the creation of complex and costly computer software and mechanical apparatus to control plate exposure.

In the apparatus of the invention, a back-lit array of liquid crystal devices, or LCDs, having the same overall dimensions of the printing plate to be exposed is provided so the full imaging surface of a photosensitive printing plate can be exposed at one time, without movement of the array or the plate during the exposure process. Because the full area of the plate is exposed at one time, the exposure can be accomplished in a short time, and because neither the array nor the plate is moved during the exposure process, the need for complex apparatus to move the light source or the plate, and the possibility of movement control errors are eliminated.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a face view of an embodiment of the LCD component apparatus of the invention.

FIG. 1A is a magnified face view of a small portion of the LCD component.

FIG. 2 is a side view of one embodiment of apparatus for use of the invention, with a printing plate positioned for exposure.

FIG. 2A is a side view of one embodiment of apparatus for use of the invention, with a printing plate positioned for exposure

FIG. 3 is a side view of another embodiment of apparatus for use of the invention, with a printing plate positioned for exposure.

FIG. 4 is a side view of a further embodiment of apparatus for use of the invention, with a printing plate positioned for exposure.

FIG. 5 is a face view of an embodiment of the LED component apparatus of the invention.

FIG. 5A is a magnified face view of a small portion of the LED component.

FIG. 6 is a side view of an apparatus f r simultaneous exposure of a two-sided plate.

FIG. 7 is a typical plate exposure apparatus common in the art.

### DETAILED DESCRIPTION OF THE INVENTION

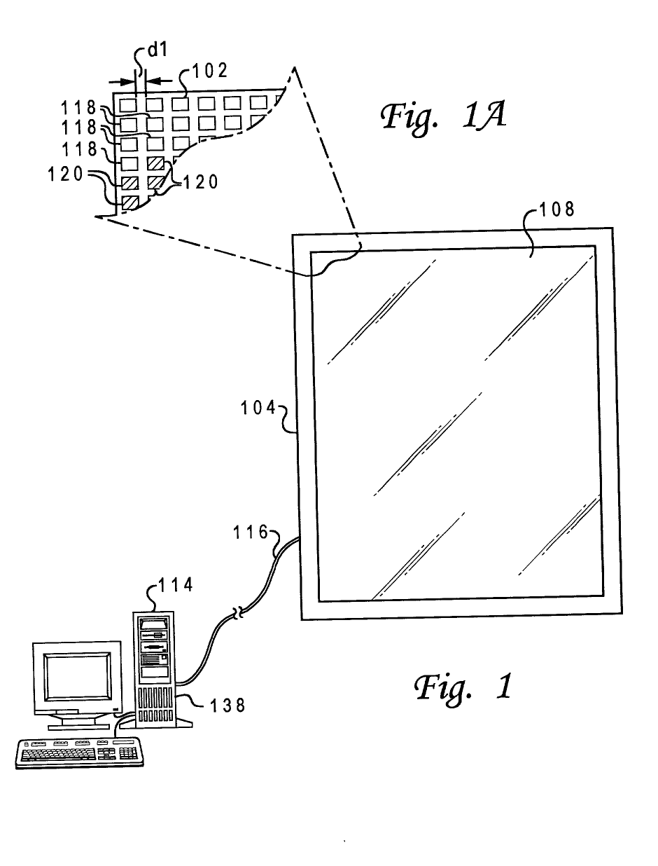

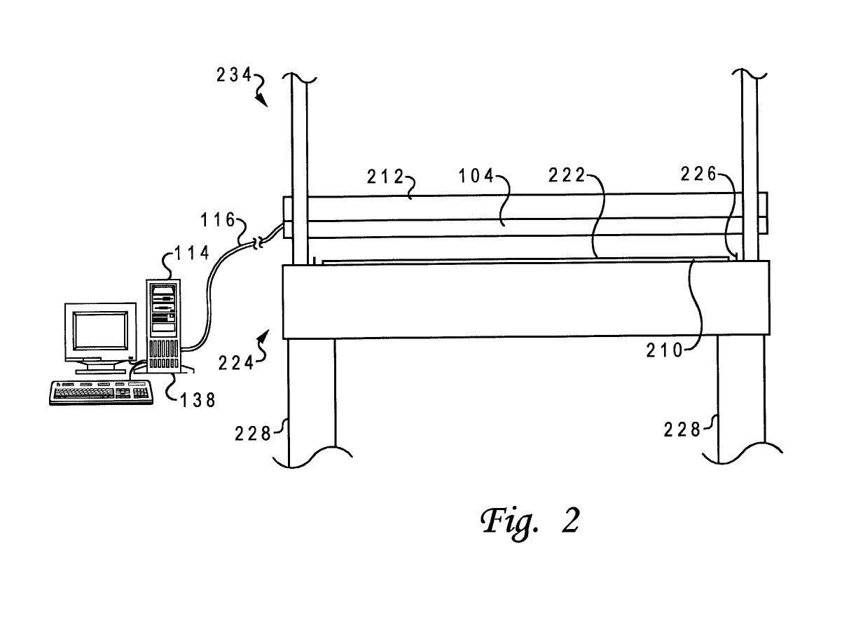

In the apparatus of the invention, a plurality of LCDs 102 are arrayed in a closely spaced regular pattern, and can be in the same plane. FIG. 1 provides an illustration of one embodiment of an LCD component 104. The component 104 comprises a grid of electrical wires and a liquid crystal solution. It is to be understood that other patterns may used within the scope of the invention. The LCDs 102 are disposed in or on a suitable light transmitting substrate or support in the conventional manner, as used, for example, in the construction of LCD display screens. The resulting LCD component 104 may be conceptually analogized to a large, flat screen computer monitor. A transparent screen 108 may be placed over the outer face of the component 104, to seal the structure against dust, moisture, and other contaminants, and to protect the LCDs 102 from physical damage. The spacing dl between the LCDs 102, and thus the effective “resolution” of the image produced by the component 104 is determined in accordance with the quality or resolution requirements for the final printed product. The overall dimensions of the component 104 is approximately the size of the printing plate 210 and will depend upon the dimensions of the printing plates 210 to be exposed, which is determined by the size of the final printed image to be produced. Each LCD 102 is connected so that it maybe individually activated. A light source 212 is disposed behind the component 104, so that light from the light source 212 passes through the LCDs 102. The component 104 and the light source 212 are connected to a computer system 114, by, e.g., a control cable 116. The activation of individual LCDs 102 within the component 104 are controlled by video hardware and software in generally the same manner as a monochrome monitor display, and activation of the light source 212 to direct light through the component 104 is also controlled from the computer 114 in coordination with activation of the component 104. Light source 212 is preferably a UV light source, however, light source 212 could be any conventional light source such as filtered or polarized white light or infrared light. FIG. 2 shows the component 104 a defined distance from printing plate 210. FIG. 2A shows the component 104 with a defined distance of zero from the printing plate 210.

The LCDs 102 used in the apparatus of the invention comprise a transparent liquid that, when activated by an electrical signal, becomes opaque to the transmission of light. When the activating signal is removed, the liquid becomes transparent again. Light produced by light source 212 passes through unactivated LCDs 118 in the component 104, but is blocked by activated LCDs 120 in much the same way that exposure light is blocked by the image area of a film sheet used in conventional methods of printing plate preparation. LCDs 102 in the apparatus of the invention may be selectively activated to produce the image to be printed on the face of the component 104. When the light source 212 is activated, light is allowed to pass through the non-activated LCD structures 118, but is blocked by the activated LCDs 120. Notably, this method could be reversed depending on whether the plate used is either positive or negative. In the case of a positive plate, the photosensitive surface corresponding to the printed image are not exposed, however, in the case of a negative plate the portion of the photosensitive surface corresponding to the printed image are exposed. Both postive and negative plates can be used with the present invention. Also, instead of an LCD, a different material could be used such as a polymer that becomes clear when exposed to an electric signal. In the conventional approach to printing plate exposure, a separate film sheet 704 must be used for each exposure, so the apparatus used must be designed to accommodate placement and alignment of the film sheet 704 before each exposure. Unlike the conventional approach, the method of the invention does not require the replacement of film sheets 704, and the apparatus may be constructed with the light source 212 in generally fixed relationship to the component 104, simplifying both the apparatus and the process of plate exposure.

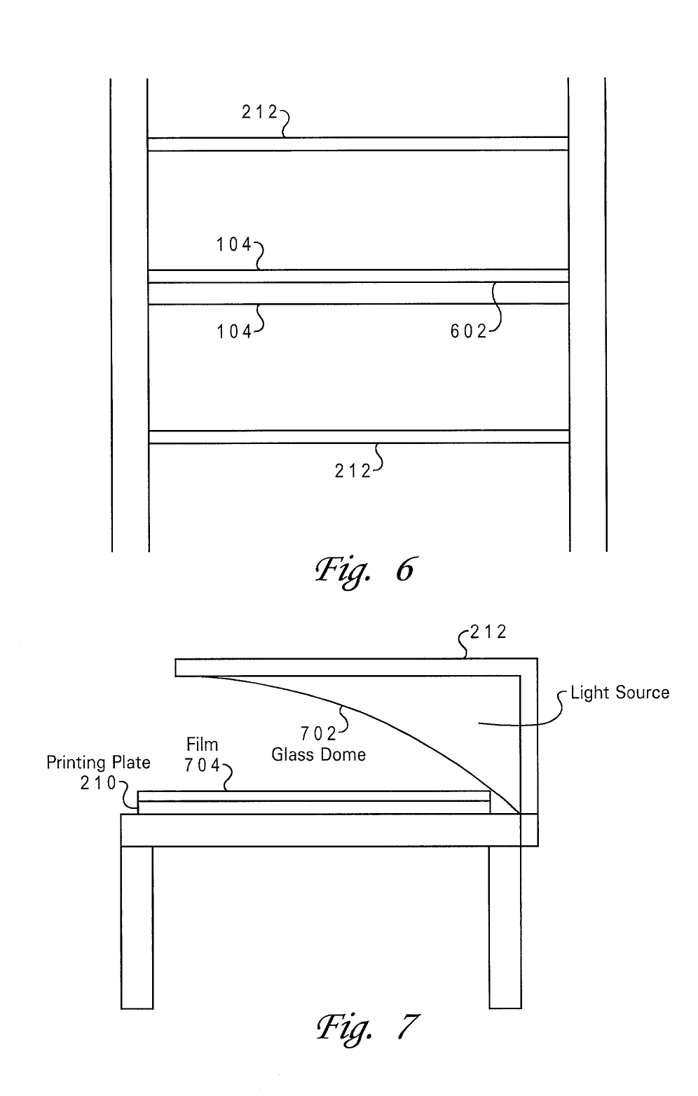

The support and positioning assembly 224 for the apparatus of the invention may be structurally similar to the apparatus used for conventional plate exposure. In the conventional approach a prepared photographic film sheet 704 is aligned in a holder or carrier and moved into position over the printing plate 210, then a glass frame 702 is positioned directly on top of the film 704 which is on the printing plate 210 wherein the printing plate 210 is supported by a solid support. See FIG. 7. A vacuum is drawn under the glass frame to remove bubbles and to insure intimate contact between the glass frame 702, film 704, and printing plate 210. Light from a separate light source 212 is directed through the film onto the printing plate 210. Since the step of moving the film into position over the printing plate 210 in the conventional approach is analogous to positioning the printing plate 210 and the component 104 in the method of the invention, positioning apparatus 224 of generally analogous design maybe used. As with the conventional approach, it is important that the position of the printing plate 210 in the apparatus be carefully controlled in order to specifically determine the area of the printing plate 210 that is exposed, especially when the final printed image is produced on the printing press using a plurality printing plates 210 with each printing plate 210 printing a portion of the final image. However, since the method of the invention eliminates the use of film 704, it also reduces the complexity of the printing plate 210 exposure operation because the film 704 alignment step is eliminated and because the component 104 position is precisely maintained by the support and positioning assembly 224.

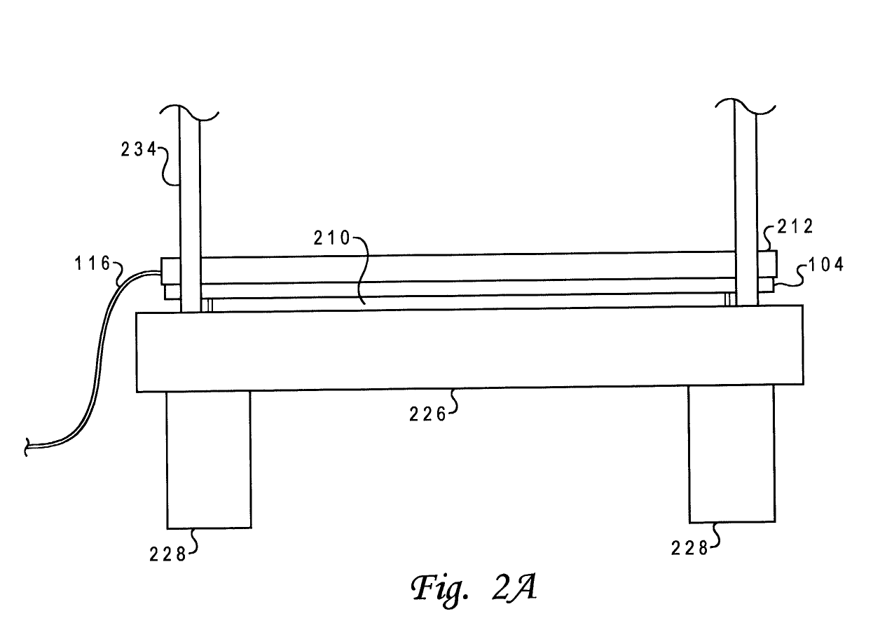

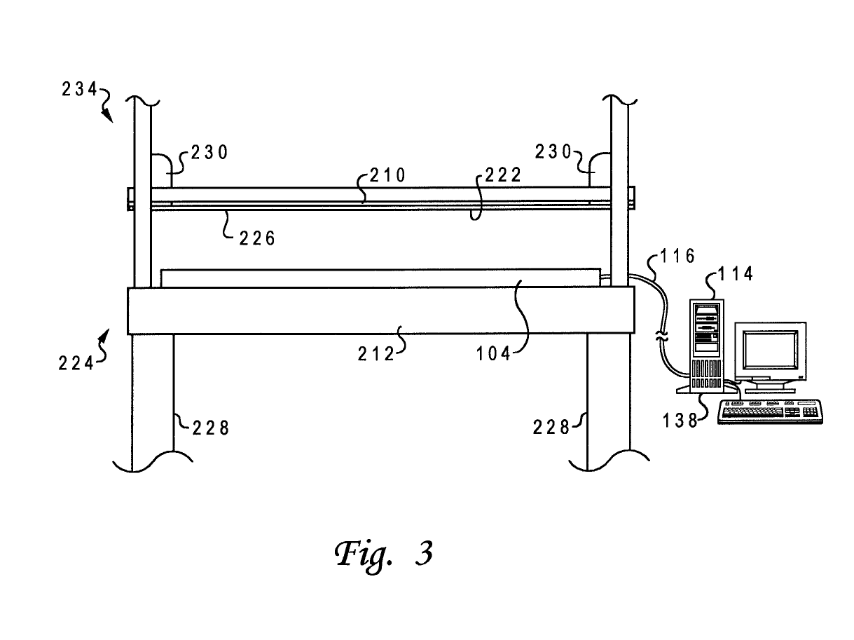

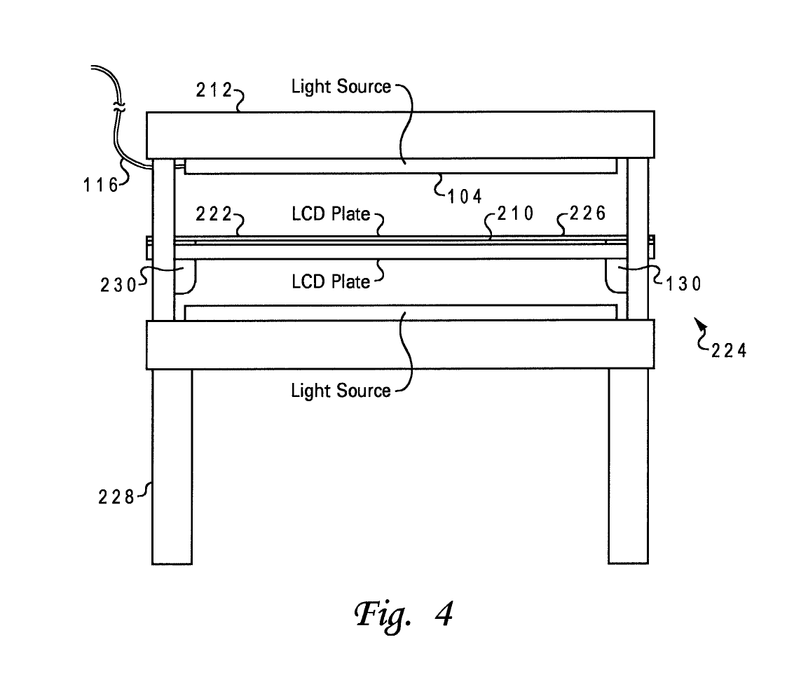

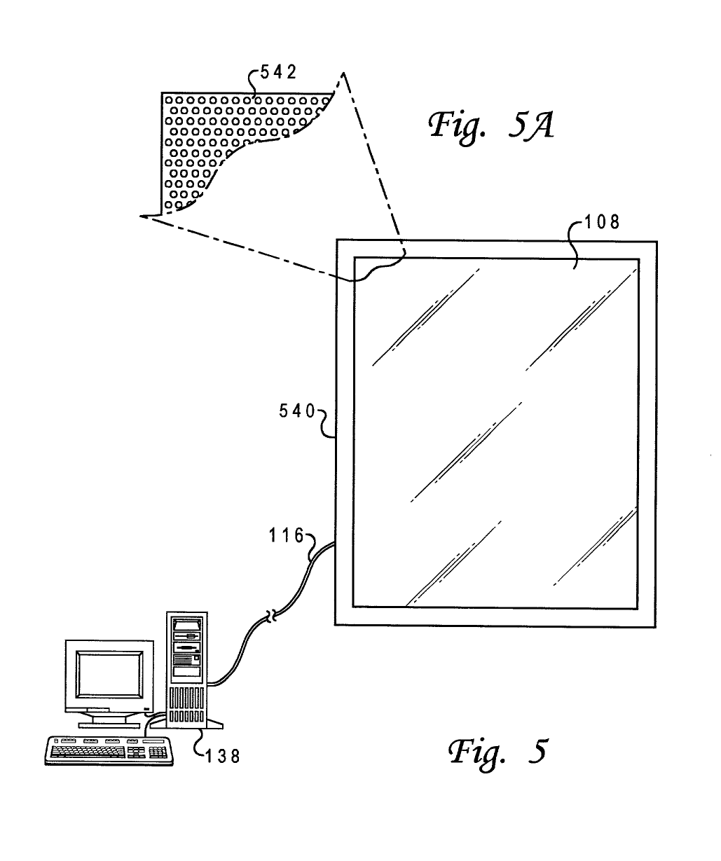

The component 104 maybe incorporated into the glass frame 702 or replace the conventional glass frame 702 so the apparatus of conventional design may be used, with the component 104 replacing the film 704. The component structure 104 is typically disposed horizontally and oriented so that the light emitted through the LCD 102 is directed downward. A vacuum is drawn under the component 104 to remove bubbles and to insure intimate contact between the component 104 and the coated surface 222 of the printing plate 210. The assembly may include a vacuum frame or similar plate holder 226 that can create a vacuum between the component 104 and the coated surface 222 of the printing plate 210 and to receive and position the printing plate 210 to be exposed with the coated surface 222 of the printing plate 210 facing the component 104. As an alternate embodiment, the component 104 structure, with affixed light source 212, is supported in a support and positioning assembly 224, as generally illustrated in FIGS. 2, 3 and 4. In the embodiment illustrated in FIGS. 2 and 3 the component 104 structure and the plate holder 226 are supported in vertical alignment by four vertical rails 228. The apparatus also includes a positioning means 230 for positioning the component 104 a predetermined distance from the surface of the printing plate 210 before the light source 212 is activated to emit light to expose the coated surface 222 of the printing plate 210. The predetermined distance may be as small as approximately zero to as large as few centimeters. The positioning means 230 may operate to move the component 104 downward to a fixed plate holder 226, as in FIG. 2, or, alternatively, to move the plate holder 226 downward to a fixed component 104, as in FIG. 3. The support and positioning assembly 224 may also be arranged so that the printing plate 210 is moved upward to a fixed component 104 structure, as in FIG. 4. In the case of a two-sided printing plate 602 having two sides with photo-sensitive coating 222, two components 104 may sandwich the two sided printing plate 602 to allow for simultaneous exposure of both sides, as shown in FIG. 6. When the two sided printing plate 602 is exposed, the process is generally the same as above, except one component 104 is above the two sided printing plate 602 and the other component 104 is below the two sided printing plate 602, as shown in FIG. 6.

Images to be “transferred” to the printing plate 210 using the apparatus and method of the invention are stored in digital format in or on any computer readable storage media 138, including “permanent” media such a magnetic or optical disks, or even “temporary” storage media such as random access memory (RAM). The image to be printed may have been originally created on a computer as text and/or image files, or may have been originally created on other media such as paper or photographic film and scanned and processed to create a digital image file. When the image is to be printed in a single color and only one printing plate is required for the physical printing process, the complete image is processed and viewed on a computer monitor for verification that the image is ready to be transferred to a printing plate. The printing plate 210 is placed in the apparatus with the photo-sensitive coating 222 facing the component 104 and light source 212, and aligned for exposure. The positioning means 234 of the apparatus is activated to position the non-exposed plate printing 210 and the component 104 for exposure. The plate exposure process is then initiated by the computer operator through a software command to process the digital image file information through the computer hardware and selectively activate LCDs 102 in the component 104, forming the image to be “transferred” to the plate printing 210, and the light source 212 is activated, thereby exposing the printing plate 210 to the light emitted through the component 104 in the pattern of the image to be printed. When the exposure is completed and the light source 212 and LCDs 102 are deactivated, the exposed plate printing 210 is removed from the apparatus and prepared for use in the conventional manner.

When the image to be printed requires the use of more than one color ink, an additional processing step is performed, utilizing the computer system and appropriate software, to create color separations of the image. Each color separation includes only the portion of the image to be printed in a single color, and a printing plate is prepared for each of the colors to be combined to produce the complete, final image. The preparation of each printing plate 210 using the method and apparatus of the invention is done in the same manner as described above, with the LCDs 102 of the component 104 selectively activated to expose a printing plate 210 with each separation image.

In an alternative embodiment of the invention, an array of light emitting diodes (LEDs) 542 are used in place of the LCD component 104, and light source 212 is omitted. The LEDs 542 in the LED component 540 are selected to emit light of a frequency and intensity that is effective for producing the desired reaction of the selected plate coating to be exposed. Light is emitted by each LED 542 in a tightly focused beam, and an image is produced on the photo-sensitive surface of a printing plate 210 positioned in the path of the light emitted by the component 540 as various individual LEDs 542 are selectively activated.

The process of exposing the surface of a photo-sensitive printing plate 210 using the LED component 540 is much the same as the LCD component 104 in the preferred embodiment. With the printing plate 210 and the LED component 540 aligned and positioned, the digital file information for the image to be transferred to the printing plate 210 is processed through the computer hardware to activate selected LEDs 542 in the LED component 540, emitting light in the pattern of the image to be “transferred” to the plate printing 210, thereby exposing the printing plate 210. When the exposure is completed and the LEDs 542 are deactivated, the exposed plate printing 210 is removed from the apparatus and prepared for use.

Both the preferred LCD and alternative LED embodiments of the invention can be readily “retrofitted” to conventional printing plate exposure apparatus, allowing printers to achieve the primary benefits and advantages of “computer to plate” printing technology without incurring the high costs of replacing their conventional plate exposure apparatus with completely new apparatus. With the preferred LCD embodiment, a printer can achieve direct to plate exposure capability by replacing only the film sheet holding components of conventional plate exposure equipment with the LCD component of the invention, retaining the conventional light source. With the alternative LED embodiment, both the conventional film holding components and light source are replaced with the LED component.

It is to be understood that the foregoing description of preferred and alternative embodiments of both the apparatus of the invention and of the method of the invention is illustrative, and the scope of the invention is not limited to the specific embodiments or structural arrangements of the apparatus described. A variety of means may be employed to support and position the LED component and/or the printing plates to be exposed, all within the scope of the invention.

While the invention has been shown in only one of its forms, it is not thus limited but is susceptible to various changes and modifications without departing from the spirit thereof.

What is claimed is:

1. A method of exposing photo-sensitive plates in preparation for using the plates to produce printed images, the method comprising:
providing at least one component with a front side and a back side wherein the component either filters or allows light when activated by an electrical signal;
positioning at least one light source in spaced relationship with the back side of the component such that light from the light source is able to pass through the component;
orientating a plate having at least one photo-sensitive surface such that the photo-sensitive surface of the printing plate faces the front side of the component;
positioning the component and the plate a predetermined distance from each other;
activating the component such that the component either filters or allows light; and
activating the light source, thereby exposing the photo-sensitive surface of the printing plate.

2. The method of claim 1 further comprising:
two separate and distinct components;
two separate and distinct light sources; and
a plate having two opposing photo-sensitive surfaces sandwiched between the two separate components to allow for simultaneous exposure of both sides of the printing plate.

3. The method of claim 1 wherein the component is activated by a computer.

4. The method of claim 1 wherein the component is in a fixed position and the printing plate is moved to achieve the predetermined distance.

5. The method of claim 1 wherein the printing plate is in a fixed position and the component is moved to achieve the predetermined distance.

6. The method of claim 1 wherein the predetermined distance is approximately zero and a vacuum is created to remove bubbles and insure intimate contact between the component the photo-sensitive surface of the plate.

7. The method of claim 1 wherein the component comprises means for selectively causing portions of the component to filter or allow light.

8. The method of claim 7 wherein the means comprise a grid of electrical wires and a liquid crystal solution.

9. The method of claim 8 wherein the spacing between the grid of electrical wires is determined by the user in accordance with the quality or resolution requirements for the final printed product.

10. The method of claim 9 wherein the grid of electrical wires has the same overall dimensions of a printing plate to be exposed.

11. Apparatus for exposing photo-sensitive plates in preparation for using the plates to produce printed images, the apparatus comprising:
at least one component with a front side and a back side wherein the component either filters or allows light when activated by an electrical signal;
at least one light source in spaced relationship with the back side of the component such that light from the light source is able to pass through the component;
a plate having at least one photo-sensitive surface such that the photo-sensitive surface of the plate faces the front side of the component; and
means for positioning the component and the plate a predetermined distance from each other.

12. The apparatus of claim 11 wherein the component comprises means for selectively causing portions of the component to filter or allow light.

13. The apparatus of claim 11 wherein the means for selectively causing portions of the component to filter or allow light comprises a grid of electrical wires and a liquid crystal solution.

14. The apparatus of claim 13 wherein the spacing between the grid of electrical wires is determined by the user in accordance with the quality or resolution requirements for the final printed product.

15. The method of claim 14 wherein the grid of electrical wires has the same overall dimensions of a printing plate to be exposed.

16. The apparatus of claim 11 wherein the predetermined distance is approximately zero and a vacuum is created to remove bubbles and insure intimate contact between the component the photo-sensitive surface of the plate.

17. The apparatus of claim 11 further comprising:
two separate and distinct components;
two separate and distinct light sources; and
a plate having two opposing photo-sensitive surfaces sandwiched in between the two separate components to allow for simultaneous exposure of both sides of the printing plate.

18. The apparatus of claim 11 further comprising a transparent screen over the outer face of the material to seal the structure against dust, moisture and other contaminants, and to protect the material from physical damage.

19. Apparatus for exposing photo-sensitive printing plates in preparation for using the plates to produce printed images, the apparatus comprising:
a material having a front side that emits light when activated by an electrical signal;
a plurality of the material arrayed in a closely spaced regular pattern in the same plane wherein the array has approximately the same overall dimensions of the photo-sensitive surface; and
a printing plate having a photo-sensitive surface such that the photo-sensitive surface of the printing plate faces the front side of the material.

20. The apparatus of claim 19 wherein the material is a LED light that emits light when activated by a computer.
